(19) United States
(12) Patent Application Publication
(10) Pub. No.: US 2006/0019518 A1
(43) Pub. Date: Jan. 26, 2006

(54) Integrated circuit socket with power buss bar connector

(76) Inventors: Hue Lam, Portland, OR (US); Hong W. Wong, Portland, OR (US)

Correspondence Address: BUCKLEY, MASCHOFF, TALWALKAR LLC, 5 ELM STREET, NEW CANAAN, CT, 06840, US

(21) Appl. No.: 10/895,605

(22) Filed: Jul. 21, 2004

(51) Int. Cl. H01R 25/00

(52) U.S. Cl. 439/119

(57) ABSTRACT

According to some embodiments, an integrated circuit socket has a power buss bar connector.

### BACKGROUND

A socket may be used to attach an integrated circuit to a substrate. For example, a processor may be inserted into a socket that is mounted on a printed circuit board. A set of signal inputs and/or outputs on the integrated circuit (e.g., signal pins or contacts) may be electrically connected to signal traces on the printed circuit board via signal paths through the socket. The signal traces, in turn, may lead to other components that are on the printed circuit board (e.g., other integrated circuits). As a result, the signal inputs and/or outputs may be used, for example, to exchange information with another processor or a memory unit.

One or more power inputs on the integrated circuit may also be electrically coupled to power traces on the printed circuit board through the socket. These power traces, in turn, may lead to a voltage regulator that provides power to the integrated circuit. As processing speeds and component power consumption increase, however, it may become difficult to efficiently route signal and power traces and still supply an appropriate amount of current and/or achieve an appropriate voltage tolerance for an integrated circuit.

### BRIEF DESCRIPTION OF THE DRAWINGS

FIG. 1 is a block diagram of an apparatus.

FIG. 2 is a side view of an apparatus according to some embodiments.

FIG. 3 is a side view of an apparatus according to some embodiments.

FIG. 4 is a top view of an apparatus according to some embodiments.

FIG. 5 is a top view of an apparatus according to another embodiment.

FIG. 6 illustrates a method of providing power to an integrated circuit according to some embodiments.

FIG. 7 is a system according to some embodiments.

### DETAILED DESCRIPTION

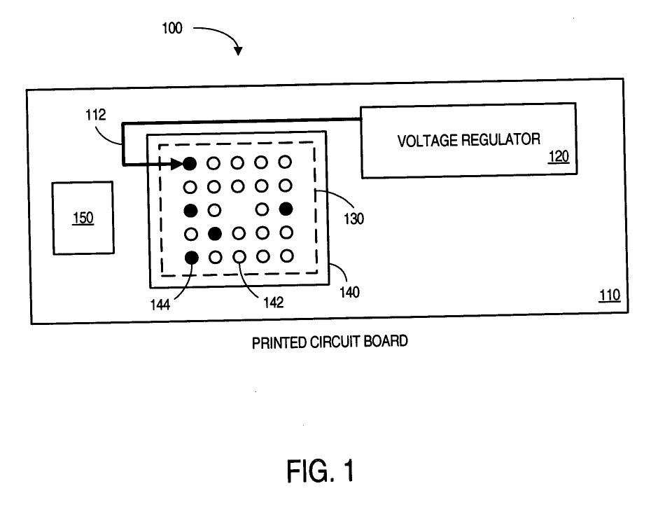

FIG. 1 is a block diagram of an apparatus 100 that includes a voltage regulator 120 and/or related components coupled to a printed circuit board 110 (e.g., a mobile computer's motherboard). The voltage regulator 120 may, for example, generate a core voltage to provide power for an integrated circuit 130 (e.g., an integrated circuit package or chip). As indicated by the dashed lines in FIG. 1, the integrated circuit 130 has been removed from the illustration for clarity.

The integrated circuit 130 may be removably coupled to a socket 140 that is also attached to the printed circuit board 110. Moreover, a set of signal inputs and/or outputs (e.g., signal pins or contacts) on the integrated circuit 130 may be electrically connected to traces on the printed circuit board 110 via signal paths 142 through the socket 140 (e.g., to exchange information via a system bus). In FIG. 1, the signal paths 142 are represented by white circles.

One or more power inputs on the integrated circuit 130 may also be electrically coupled to power traces 112 on the printed circuit board 110 via power paths 144 through the socket 140. In FIG. 1, the power paths 144 are represented by black circles. In this way, power from the voltage regulator 120 may be routed through the power trace 112 and then provided to the integrated circuit 130.

Note that the integrated circuit 130 may receive power via multiple power inputs, and the location of these power inputs might not be evenly distributed. For example, as illustrated in FIG. 1, the left side of the integrated circuit 130 is associated with more power inputs (an associated power paths 144) as compared to the right side. As a result, it might be advantageous to locate the voltage regulator 120 proximate to the left side of the socket 140. For example, reducing the length of the power traces 112 from the voltage regulator 120 to the socket 140 may reduce power loss and improve the tolerance of the voltage signal that is received by the integrated circuit 130.

In some layouts, however, other considerations may make it impractical to locate the voltage regulator 120 in a desirable position with respect to power. For example, a different component 150 might be placed in that location to improve the performance of the apparatus for other reasons. The other component 150 might be, for example, a Graphics and Memory Controller Hub (GMCH) or a Small Outline (SO) Dual Inline Memory Module (DIMM).

In this case, one or more power traces 112 may need to be routed between the socket 140 and a remote voltage regulator 120. As processing speeds increase, however, greater amounts of current may need to be provided to the integrated circuit 130—and the power loss and degraded tolerances associated with long power traces 112 may be substantial. Moreover, long power traces 112 might restrict where and how other busses can be routed. For example, signal traces associated with a Front Side Bus (FSB) or a dual Double Data Rate (DDR) memory unit might require additional printed circuit board layers because of the long power traces 112, which could increase the cost of the apparatus 100.

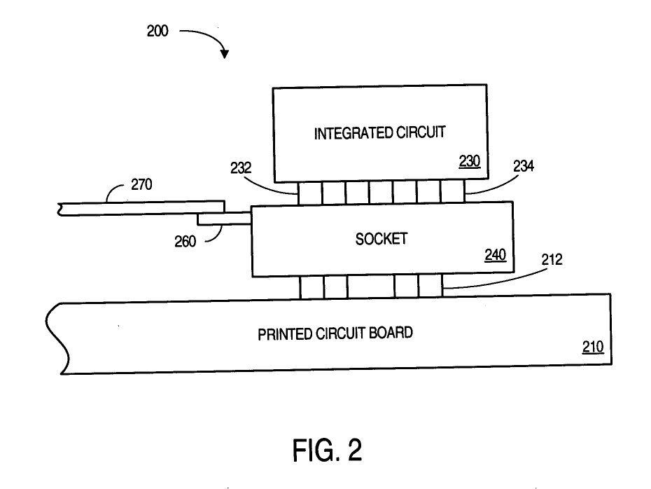

FIG. 2 is a side view of an apparatus 200 according to some embodiments. The bottom surface of a socket body 240 is coupled to a printed circuit board 210 and the top surface is coupled to an integrated circuit 230. The socket body 240 may be formed, for example, with plastic or another non-conducting material. Note that the printed circuit board 210, socket body 240, and/or integrated circuit 230 may be coupled using any known technique (e.g., pin, ball, and/or solder connections).

Within the socket body 240, a set of signal paths route signals between signal inputs and/or outputs 232 on the integrated circuit 230 and traces on the printed circuit board 210. In addition, at least one power input 234 on the integrated circuit 230 is electrically coupled to a connector 260. The connector 260 may be, for example, a copper tab extending from a side of the socket body 240.

The connector 260 is also electrically coupled to a power buss bar 270. The power buss bar 270 may, for example, be a copper rod or wire that electrically couples the connector 260 (and therefore the integrated circuit's power input 234) to a voltage regulator or other power source. The power buss bar 270 and the connector 260 may be physically coupled, for example, by a threaded connection (e.g., a threaded portion of the power buss bar 270 may screw into or over a threaded portion of the connector 260), a solder connection, a nut and bore clamp-on, or a spring connection. As illustrated in FIG. 2, the connector 260 may be located external to socket body 240. According to other embodiments, a connector may be located within a socket body (e.g., and the power buss bar 270 may be inserted or plugged into the socket body).

Note that according to some embodiments, the power buss bar 270 is not directly attached to the printed circuit board 210. In this way, a significant amount of current may be supplied from a voltage regulator to the integrated circuit 230 without restricting the routing of other signals. According to some embodiments, the power buss bar 270 may extend from the connector 260 to a trace located remote from the socket 240 body (e.g., which in turn leads to a voltage regulator).

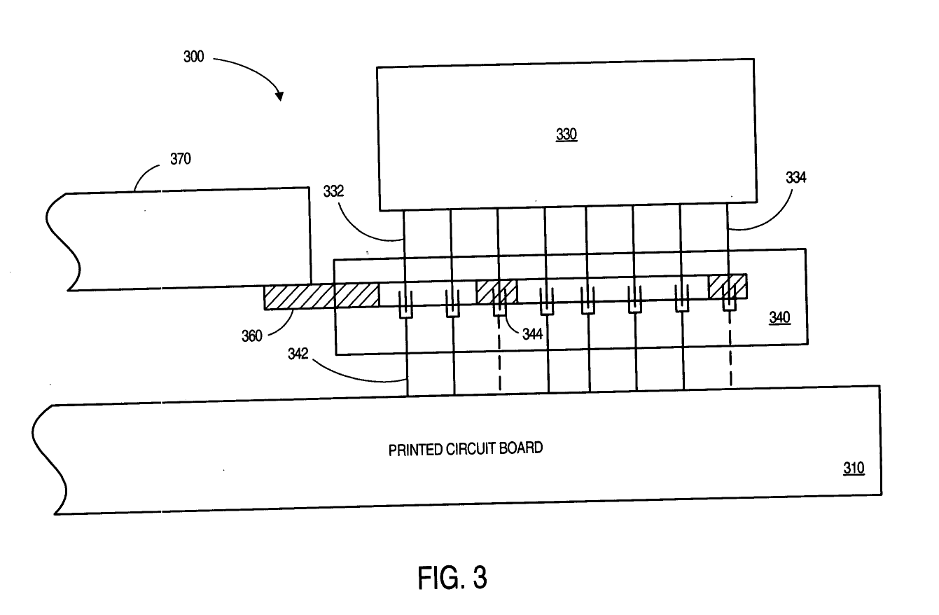

FIG. 3 is a side view of an apparatus 300 according to some embodiments. As before, the apparatus 300 includes a socket body 340 having a bottom surface coupled to a printed circuit board 310 and a top surface coupled to an integrated circuit 330. According to this embodiment, signal pins 332 and power pins 334 extend from the integrated circuit 330 and are received within the socket body 340. Moreover, a set of signal paths 342 route signals between signal pins 332 and traces on the printed circuit board 310.

According to this embodiment, at least one power pin 334 on the integrated circuit 330 is electrically coupled to a power plane 360. In the example illustrated in FIG. 3, two power pins 334 are coupled to the power plane 360 via receiving portions 344 adapted to secure integrated circuit pins. As illustrated by dashed lines in FIG. 3, the receiving portions 344 might also be coupled to the printed circuit board 310 (e.g., to provide a path from decoupling capacitors between power and ground that place on the printed circuit board 310). According to still other embodiments, such decoupling capacitors might be placed on or in the socket body 340.

The power plane 360 may be, for example, a conductive sheet or plate of copper that is substantially parallel to the printed circuit board 310. Moreover, one portion of the power plane 360 may be located within the socket body 340 and another portion may extend outside to the socket body 340 to serve as a connector (e.g., a tab shaped connector). Note that the connector portion of the power plane 360 and the portion internal to the socket body 340 might be integrally formed or might include multiple portions that are coupled together. The connector portion of the power plane 360 is also electrically coupled to a power buss bar 370 (e.g., a copper path) which in turn is electrically coupled to a voltage regulator.

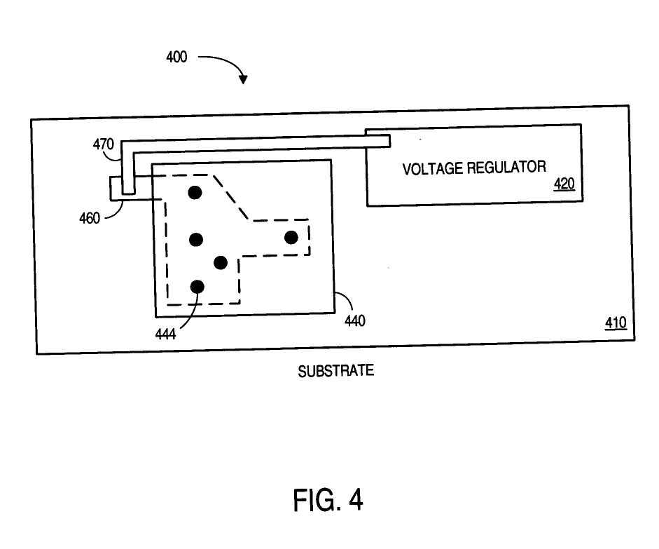

FIG. 4 is a top view of an apparatus 400 according to some embodiments. The apparatus 400 includes a voltage regulator 420 and/or related components mounted on a substrate 410. The voltage regulator 420 may, for example, generate a core voltage that provides power for an integrated circuit. The core voltage may, for example, be provided to a power plane 460 of a socket body 440 via a power buss bar 470. Moreover, one or more power inputs 444 on the integrated circuit may be electrically coupled to the power plane 460 when the integrated circuit is attached to the socket body 440. Note that while the integrated circuit and associated signal inputs and outputs are not illustrated in FIG. 4 for clarity, the location of the power inputs 444 are represented by black circles. According to some embodiments, the portion of the power plane 460 within the socket body 440 defines an area that reaches the power inputs 444 (e.g., the five power inputs 444 illustrated in FIG. 4). The power plane 460 may be formed in different shapes and configurations. According to some embodiments, the power plane 460 is made as large as practicable to reduce the resistance associated with the power plane 460.

In this example, the connector portion of the power plane 460 extends from the left side of the socket body 440. The connector portion is therefore proximate to most of the power inputs 444. In this case, the freedom to route other signal traces on the substrate 410 might not be restricted by power traces. Instead, the power buss bar 470 is used to electrically couple the connector portion to the “remote” voltage regulator 420 (“remote” because the voltage regulator 420 is not proximate to most of the power inputs 444).

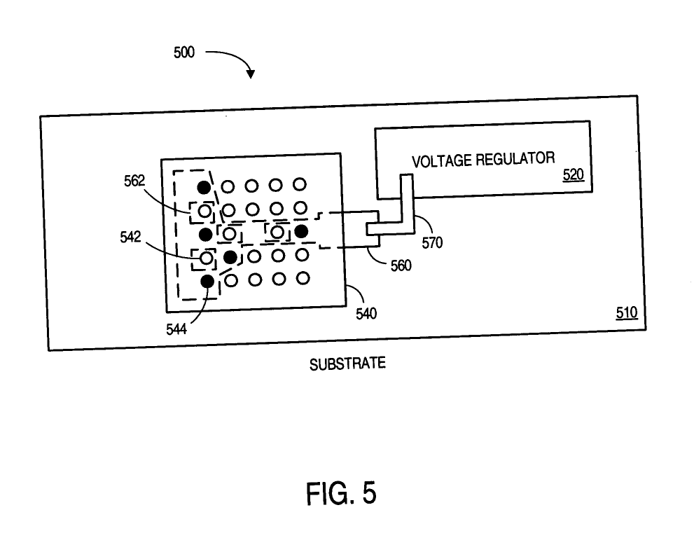

FIG. 5 is a top view of an apparatus 500 according to another embodiment. As before, the apparatus 500 includes a substrate 510 with a voltage regulator 520 that provides a core power to an integrated circuit via a socket body 540. Although the integrated circuit is not illustrated in FIG. 5 for clarity, the location of the signal inputs and outputs 542 and the power inputs 544 are represented by white and black circles, respectively.

The power inputs 544 on the integrated circuit are electrically coupled to a copper sheet or plate 560. Note that the copper plate 560 might include openings 562 that let the signal inputs and outputs 542 extend through the socket body 540 without contacting the copper plate 560.

A power buss bar 570 brings a core voltage from the voltage regulator 520 to the copper plate 560 (and therefore to the power inputs 544 on the integrated circuit). In this example, the connector portion of the copper plate 560 is located on the right side of the socket body 540 and is therefore proximate voltage regulator 520. That is, even though most of the power inputs 544 are located on the left hand side of the socket 540, the copper plate 560 lets the voltage regulator 520 be positioned proximate to the right hand side of the socket 540 without using a long power buss bar 570. Such an arrangement may, for example, reduce power loss and improve voltage tolerances associated with the apparatus 500.

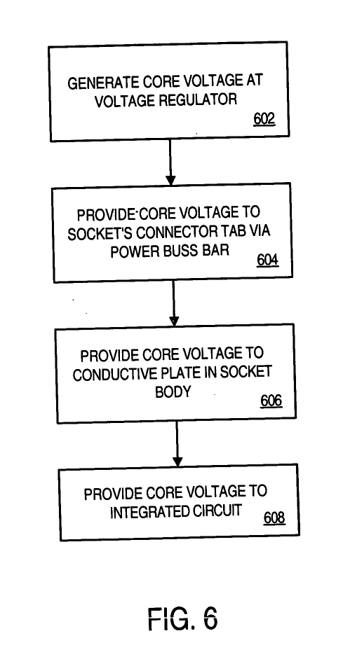

FIG. 6 illustrates a method of providing power to an integrated circuit according to some embodiments. At 602, a core voltage is generated at a voltage regulator. For example, the voltage regulator might generate V_{CORE} using power received from a battery or an Alternating Current (AC) to Direct Current (DC) adapter.

At 604, the core voltage is provided to a socket's connector tab via a power buss bar. For example, one end of a power buss bar may be electrically coupled to the voltage regulator and the other end of the power buss bar may be electrically coupled to the connector. At 606, the core voltage is provided from the connector to a conductive plate in the body of the socket. The core voltage may then be provided from the conductive plate to an integrated circuit's power input at 608.

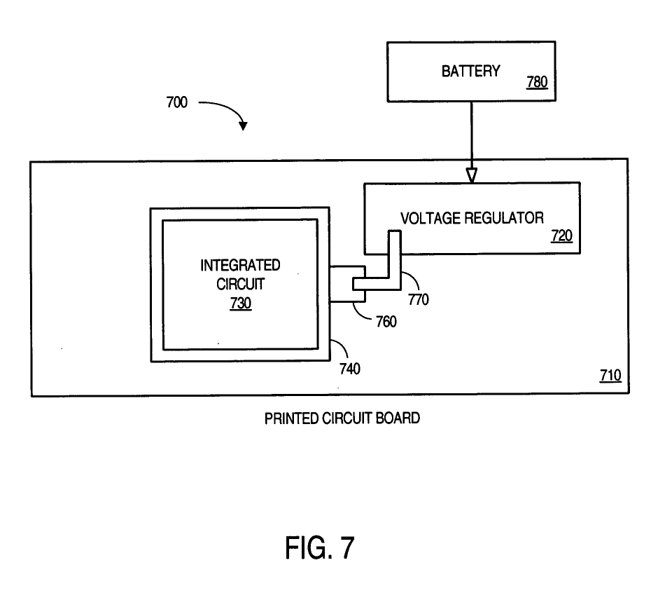

FIG. 7 is a system 700 according to some embodiments. The system includes a printed circuit board 710 on which a voltage regulator 720 is mounted. An integrated circuit 730 is also mounted on the printed circuit board 710 via a socket 740. Moreover, the voltage regulator 720 provides power to a connector 760 of the socket 740 in accordance with any of the embodiments described herein. For example, the voltage regulator 720 might receive power from a battery 780 and generate V_{CORE}. V_{CORE} may then be supplied to several power inputs of the integrated circuit 730 via the power buss bar 770 and the connector 760. According to other embodiments, a fuel cell or other power source may provide power to the voltage regulator 720.

The system 700 may comprise any computing system having an integrated circuit 730 and a socket 740. For example, the system 700 and/or integrated circuit 730 might be associated with a mobile computer, a Personal Computer (PC), a server, a handheld computer, a media computer such as a digital video recorder, and/or a game device.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

For example, although a conductive plate was described in some embodiments, note that wires or traces within a socket body might instead be used to electrically couple an integrated circuit's power inputs to a connector (and therefore to a power buss bar). Moreover, although voltage regulators have been described as being mounted on a printed circuit board or other substrate, note that a power buss bar might be used to provide power to a socket from a voltage regulator that is not located on the same substrate.

In addition, although some embodiments described a socket with a single connector, embodiments may be provided with multiple connectors (e.g., two power buss bar connectors might be provided on opposite sides of a socket body). Similarly, a socket might include both a power buss bar connector (e.g., on a side of the socket) and a power path from the top of the socket to the bottom of the socket (e.g., and such a socket could receive power via a power buss bar and/or a traditional power trace).

The several embodiments described herein are solely for the purpose of illustration. Persons skilled in the art will recognize from this description other embodiments may be practiced with modifications and alterations limited only by the claims.

What is claimed is:

1. An apparatus, comprising:
a socket body; and
a connector associated with the socket body to be electrically coupled to a power buss bar, wherein the connector is to receive power from the power buss bar and to provide power to a power input of an integrated circuit.

2. The apparatus of claim 1, further comprising:
a power plane associated with the socket body to provide power from the connector to the power input of the integrated circuit.

3. The apparatus of claim 2, wherein an integrated circuit is to be coupled to one surface of a socket body, a substrate is to be coupled to another side of the socket body, and further comprising:
a set of signal paths to route signals between the integrated circuit and traces on the substrate.

4. The apparatus of claim 3, wherein the set of signal paths and the power plane are to be electrically coupled to the integrated circuit via at least one of: (i) integrated circuit pins, or (ii) integrated circuit contacts.

5. The apparatus of claim 3, wherein the integrated circuit is to be coupled to a top surface of the socket body, the substrate is to be coupled to a bottom surface of the socket body opposite the top surface, and the connector is associated with a first side of the socket body.

6. The apparatus of claim 5, wherein the power input of the integrated circuit is proximate to a second side of the socket body.

7. The apparatus of claim 5, wherein the power input of the integrated circuit is proximate to the first side of the socket body and a power buss bar is to be routed from the connector to a voltage regulator that is not proximate to the first side of the socket body.

8. The apparatus of claim 3, wherein the substrate is printed circuit board.

9. The apparatus of claim 8, further comprising:
a power buss bar coupled to the connector and to a voltage regulator mounted on the printed circuit board remote from the socket body.

10. The apparatus of claim 9, wherein the power buss bar is not directly attached to the printed circuit board.

11. The apparatus of claim 2, wherein the power plane comprises a conductive plate, wherein at least a portion of the conductive plate is (i) substantially parallel to the substrate, and (ii) located within the socket body.

12. The apparatus of claim 11, wherein the connector comprises a connector tab, at least a portion of the connector tab being located outside the socket body.

13. The apparatus of claim 12, wherein the connector tab is integral with the conductive plate.

14. The apparatus of claim 1, further comprising:
a power buss bar coupled to the connector.

15. The apparatus of claim 14, wherein the power buss bar is at least one of: (i) copper, (ii) a wire, or (iii) a rod.

16. The apparatus of claim 14, wherein the power buss bar is coupled to the connector via at least one of: (i) a threaded connection, (ii) a solder connection, or (iii) a nut and bore clamp-on.

17. The apparatus of claim 1, wherein the integrated circuit is a central processing unit associated with at least one of: (i) a mobile computer, (ii) a personal computer, (iii) a server, (iv) a handheld computer, (v) a media computer, or (vi) a game device.

18. The apparatus of claim 17, wherein a plurality of power inputs provide a core voltage to the integrated circuit.

19. A method, comprising:
generating a core voltage at a voltage regulator mounted on a printed circuit board; and
supplying the core voltage to a socket connector via a power buss bar, the socket connector being associated with an integrated circuit remote from the voltage regulator.

20. The method of claim 19, wherein the power buss bar is not directly attached to the printed circuit board.

21. The method of claim 19, wherein at least a portion of the socket connector is located outside a socket body and further comprising:
supplying the core voltage from the socket connector to the integrated circuit via a conductive plate, wherein at least a portion of the conductive plate is (i) parallel to the printed circuit board, and (ii) located within the socket body

22. A system, comprising:
an integrated circuit;
a socket having one surface coupled to the integrated circuit and including a socket connector;
a power buss bar electrically coupled to the socket connector;
a battery; and
a voltage regulator electrically coupled to the power buss bar and to (i) receive power from the battery and (ii) provide a core voltage to the integrated circuit via the power buss bar.

23. The system of claim 21, wherein the integrated circuit is coupled to a top surface of the socket, a printed circuit board is coupled to a bottom surface of the socket, and the connector is located at a first side of the socket.

24. The system of claim 22, wherein the integrated circuit is a processor associated with at least one of: (i) a mobile computer, (ii) a personal computer, (iii) a server, (iv) a handheld computer, (v) a media computer, or (vi) a game device.
